(19) United States
(12) Patent Application Publication
(10) Pub. No.: US 2008/0259211 A1
(43) Pub. Date: Oct. 23, 2008

(54) Using Subtitles for Other Purposes

(75) Inventors: Christian Kraft, Frederiksberg (DK); Peter Dam Nielsen, Lyngby (DK)

Correspondence Address: BANNER & WITCOFF, LTD., 1100 13th STREET, N.W., SUITE 1200, WASHINGTON, DC, 20005-4051, US

(73) Assignee: Nokia Corporation, Espoo (FI)

(21) Appl. No.: 11/738,867

(22) Filed: Apr. 23, 2007

(51) Int. Cl. H04N 11/00

(52) U.S. Cl. 348/468; 348/E11.005

(57) ABSTRACT

Aspects of the invention are directed to using subtitles for purposes other than viewing them on a display screen overlaid on the sub-title's corresponding content. While watching television with sub-titles activated, a terminal user may be offered a short-cut and/or one or more options which will use a current (or recently occurring) subtitle for other purposes. A user may be given an opportunity to use the subtitle text for sending the subtitle as message, storing the subtitle as a calendar note, etc. In accordance with another embodiment, subtitles of media content running in the background on a media content receiver terminal may be scanned based on configurable criteria input by a user. If there is a match, the user will be notified via an alarm and may change to the media channel on which the match was found.

### FIELD OF THE INVENTION

The invention relates generally to communications networks. More specifically, the invention relates to use of subtitles in the context of digital media broadcasting.

### BACKGROUND OF THE INVENTION

Digital broadband broadcast networks enable end users to receive digital content including video, audio, data, and so forth. Using a mobile terminal, a user may receive digital content over a wireless digital broadcast network. Digital content can be transmitted in a cell within a network. A cell may represent a geographical area that may be covered by a transmitter in a communication network. A network may have multiple cells and cells may be adjacent to other cells.

A receiver device, such as a mobile terminal, may receive a program or service in a data or transport stream. The transport stream carries individual elements of the program or service such as the audio and video components of a program or service.

The usage pattern for video consumption via a mobile terminal may be quite different than the consumption on a traditional television set in a person's home, for example.

Digital video broadcasts typically handle sub-titles differently than previous analogue television systems. In digital video broadcasts, the sub-titles may be sent as separate “codes”/text strings that may be “interpreted” and displayed by a terminal.

Also, digital video broadcasting allows television stations to broadcast subtitles in multiple languages, allowing the consumer to view the subtitles in a language other than the terminal's “default” language.

Using subtitles in new ways (i.e., for purposes other than viewing the subtitles with their associated media content) to enable new ways of consuming digital broadcast media, such as digital video and digital audio, would advance the art.

### BRIEF SUMMARY OF THE INVENTION

The following presents a simplified summary in order to provide a basic understanding of some aspects of the invention. The summary is not an extensive overview of the invention. It is neither intended to identify key or critical elements of the invention nor to delineate the scope of the invention. The following summary merely presents some concepts of the invention in a simplified form as a prelude to the more detailed description below.

Aspects of the invention are directed to using subtitles for purposes other than viewing them on a display screen overlaid on the sub-title's corresponding content. While watching television with sub-titles activated, a terminal user may be offered a short-cut and/or one or more options which will use a current (or recently occurring) subtitle for other purposes. A user may be given an opportunity to use the subtitle text for sending the subtitle as message, storing the subtitle as a calendar note, etc. In accordance with another embodiment, subtitles of media content running in the background on a media content receiver terminal may be scanned based on configurable criteria input by a user. If there is a match, the user will be notified via an alarm and may change to the media channel on which the match was found. Additionally, if there is a match, the user will be given an option to store media content of the media channel on which the match was found.

Aspects of the invention are utilizing and altering features of standard ESTI 300 743 for the purpose of transferring metadata information.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 illustrates a suitable digital broadband broadcast system in which one or more illustrative embodiments of the invention may be implemented.

FIG. 2 illustrates an example of a mobile device in accordance with an aspect of the present invention.

FIG. 3 depicts example media content receiver terminal display screen shots showing an example of sending a sub-title of interest as an SMS message in accordance with an aspect of the invention.

FIG. 4 depicts example media content receiver terminal display screen shots showing an example of viewing a desired scene of a movie in response to a user configured sub-title alarm in accordance with an aspect of the invention.

FIG. 5A shows an example of using language definitions to distinguish between a subtitle stream and an associated metadata stream in accordance with an aspect of the invention.

FIG. 5B shows an example of using transport packet identifiers to distinguish between a subtitle stream and an associated metadata stream in accordance with an aspect of the invention.

FIG. 6 is a schematic diagram of a media content service provider and a media content receiver terminal in accordance with aspects of the invention.

FIG. 7 is a flow chart showing steps performed by a media content receiver terminal in accordance with an aspect of the invention.

FIG. 8 is a flow chart showing steps performed by a media content service provider in accordance with an aspect of the invention.

### DETAILED DESCRIPTION OF THE INVENTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

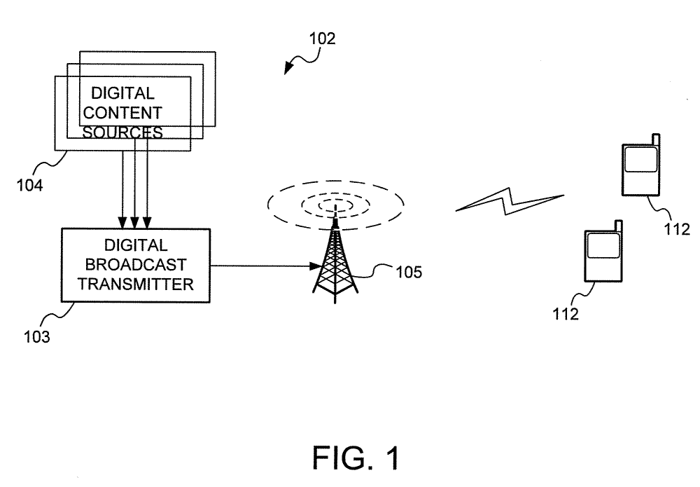

FIG. 1 illustrates a suitable digital broadband broadcast system 102 in which one or more illustrative embodiments may be implemented. Systems such as the one illustrated here may utilize a digital radio/audio/video broadcast technology, such as a digital broadband broadcast technology, for example Digital Video Broadcast-Handheld (DVB-H) or next generation DVB-H networks. Examples of other digital broadcast standards which digital broadband broadcast system 102 may utilize include Digital Video Broadcast-Terrestrial (DVB-T), Digital Video Broadcast-Satellite (DVB-S), Integrated Services Digital Broadcasting-Terrestrial (ISDB-T), Advanced Television Systems Committee (ATSC) Data Broadcast Standard, Digital Multimedia Broadcast-Terrestrial (DMB-T), Terrestrial Digital Multimedia Broadcasting (T-DMB), Satellite Digital Multimedia Broadcasting (S-DMB), Forward Link Only (FLO), Digital Audio Broadcasting (DAB), Digital Radio Mondiale (DRM), and Radio Data System (RDS), Radio Broadcast Data System (BDS), etc. Other digital broadcasting standards and techniques, now known or later developed, may also be used. Aspects of the invention may also be applicable to other multicarrier digital broadcast systems such as, for example, T-DAB, T/S-DMB, ISDB-T, and ATSC, proprietary systems such as Qualcomm MediaFLO/FLO, and non-traditional systems such 3GPP MBMS (Multimedia Broadcast/Multicast Services) and 3GPP2 BCMCS (Broadcast/Multicast Service).

Digital content may be created and/or provided by digital content sources 104 and may include video signals, audio signals, data, and so forth. Digital content sources 104 may provide content to digital broadcast transmitter 103 in the form of digital packets, e.g., Internet Protocol (IP) packets. A group of related IP packets sharing a certain unique IP address or other source identifier is sometimes described as an IP stream. Digital broadcast transmitter 103 may receive, process, and forward for transmission multiple IP streams from multiple digital content sources 104. The processed digital content may then be passed to digital broadcast tower 105 (or other physical transmission component) for wireless transmission. Ultimately, mobile terminals or devices 112 may selectively receive and consume digital content originating from digital content sources 104.

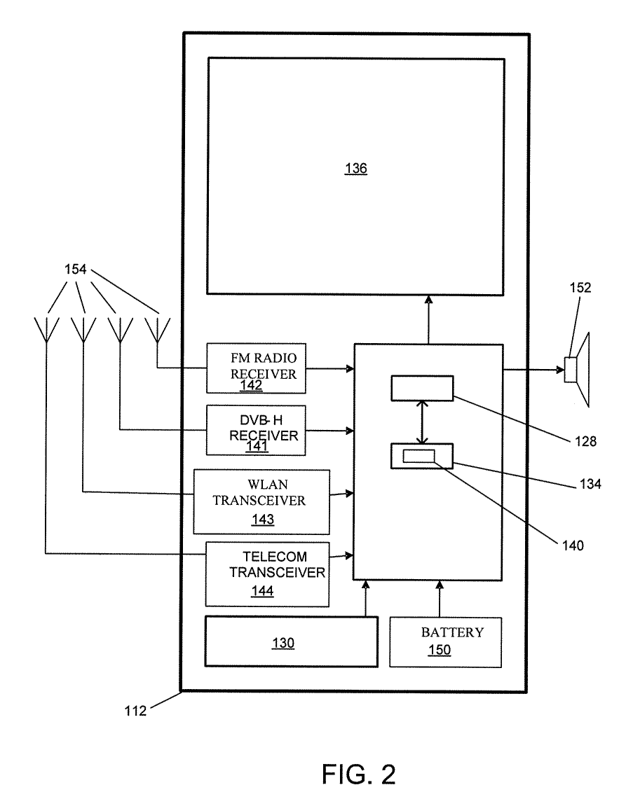

As shown in FIG. 2, depicting one aspect of the invention, a device 112 may include processor 128 connected to user interface 130, memory 134 and/or other storage, and display 136, which may be used for displaying video content, service guide information, and the like to a mobile-device user. Mobile device 112 may also include battery 150, speaker 152 and antennas 154. User interface 130 may further include a keypad, touch screen, voice interface, one or more arrow keys, joy-stick, data glove, mouse, roller ball, touch screen, or the like. The device 12 may be a mobile or a fixed device, such as a television device, a radio broadcasting receiver device, an audio/video player, a mobile phone, a mobile communication device, a PDA (Personal Digital Assistant), a digital camera, a digital camcorder, a location detection device (such as GPS (Global Positioning System) device), or any combination of the aforementioned.

Computer executable instructions and data used by processor 128 and other components within mobile device 112 may be stored in a computer readable memory 134. The memory may be implemented with any combination of read only memory modules or random access memory modules, optionally including both volatile and nonvolatile memory. Software 140 may be stored within memory 134 and/or storage to provide instructions to processor 128 for enabling mobile device 112 to perform various functions. Alternatively, some or all of mobile device 112 computer executable instructions may be embodied in hardware or firmware (not shown).

Mobile device 112 may be configured to receive, decode and process digital broadband broadcast transmissions that are based, for example, on the Digital Video Broadcast (DVB) standard, such as DVB-H or DVB-T, through a specific DVB receiver 141. The mobile device may also be provided with other types of receivers for digital broadband broadcast transmissions. Additionally, receiver device 112 may also be configured to receive, decode and process transmissions through FM/AM Radio receiver 142, WLAN transceiver 143, telecommunications transceiver 144, Bluetooth transceiver, and RFID transceiver. In one aspect of the invention, mobile device 112 may receive radio data stream (RDS) messages.

In an example of the DVB standard, one DVB 10 Mbit/s transmission may have 200, 50 kbit/s audio program channels or 50, 200 kbit/s video (TV) program channels. The mobile device 112 may be configured to receive, decode, and process transmission based on the Digital Video Broadcast-Handheld (DVB-H) standard or other DVB standards, such as DVB-Satellite (DVB-S), or DVB-Terrestrial (DVB-T). Similarly, other digital transmission formats may alternatively be used to deliver content and information of availability of supplemental services, such as ATSC (Advanced Television Systems Committee), NTSC (National Television System Committee), ISDB-T (Integrated Services Digital Broadcasting-Terrestrial), DAB (Digital Audio Broadcasting), DMB (Digital Multimedia Broadcasting), FLO (Forward Link Only) or DIRECTV. Additionally, the digital transmission may be time sliced, such as in DVB-H technology. Time-slicing may reduce the average power consumption of a mobile terminal and may enable smooth and seamless handover. Time-slicing entails sending data in bursts using a higher instantaneous bit rate as compared to the bit rate required if the data were transmitted using a traditional streaming mechanism. In this case, the mobile device 112 may have one or more buffer memories for storing the decoded time sliced transmission before presentation.

In addition, an electronic service guide may be used to provide program or service related information. Generally, an Electronic Service Guide (ESG) enables a terminal to communicate what services are available to end users and how the services may be accessed. The ESG includes independently existing pieces of ESG fragments. Traditionally, ESG fragments include XML and/or binary documents, but more recently they have encompassed a vast array of items, such as for example, a SDP (Session Description Protocol) description, textual file, or an image. The ESG fragments describe one or several aspects of currently available (or future) service or broadcast program.

Such aspects may include for example: free text description, schedule, geographical availability, price, purchase method, genre, and supplementary information such as preview images or clips. Audio, video and other types of data including the ESG fragments may be transmitted through a variety of types of networks according to many different protocols. For example, data can be transmitted through a collection of networks usually referred to as the “Internet” using protocols of the Internet protocol suite, such as Internet Protocol (IP) and User Datagram Protocol (UDP). Data is often transmitted through the Internet addressed to a single user. It can, however, be addressed to a group of users, commonly known as multicasting. In the case in which the data is addressed to all users it is called broadcasting.

One way of broadcasting data is to use an IP datacasting (IPDC) network. IPDC is a combination of digital broadcast and Internet Protocol. Through such an IP-based broadcasting network, one or more service providers can supply different types of IP services including on-line newspapers, radio, and television. These IP services are organized into one or more media streams in the form of audio, video and/or other types of data. To determine when and where these streams occur, users refer to an electronic service guide (ESG). One type of DVB is Digital Video Broadcasting-Handheld (DVB-H). The DVB-H is designed to deliver 10 Mbps of data to a battery-powered terminal device.

DVB transport streams deliver compressed audio and video and data to a user via third party delivery networks. Moving Picture Expert Group (MPEG) is a technology by which encoded video, audio, and data within a single program is multiplexed, with other programs, into a transport stream (TS). The TS is a packetized data stream, with fixed length packets, including a header. The individual elements of a program, audio and video, are each carried within packets having a unique packet identification (PID). To enable a receiver device to locate the different elements of a particular program within the TS, Program Specific Information (PSI), which is embedded into the TS, is supplied. In addition, additional Service Information (SI), a set of tables adhering to the MPEG private section syntax, is incorporated into the TS. This enables a receiver device to correctly process the data contained within the TS.

As stated above, the ESG fragments may be transported by IPDC over a network, such as for example, DVB-H to destination devices. The DVB-H may include, for example, separate audio, video and data streams. The destination device must then again determine the ordering of the ESG fragments and assemble them into useful information.

In accordance with aspects of the invention, subtitles may be used for purposes other than viewing them on a display screen overlaid on the sub-title's corresponding content.

While watching television with sub-titles activated, a terminal user may be offered a short-cut and/or one or more options which will use a current (or recently occurring) subtitle for other purposes. Alternatively, a user may program the terminal to record subtitles from a given media content program (not requiring that the user to pay attention to the program). Or the user may program the terminal to record subtitles that are shown in a given time period of a program. In this way, the user can specify a time period of a program when an event of interest is expected to occur, such as a classic one-liner.

Since subtitles being shown on a terminal may change rapidly, the terminal may store recently occurring subtitles (for instance, subtitles that occurred within a configurable amount of time in the past) thereby allowing the user some time to react and select a desired sub-title.

When the user chooses to use the text of a subtitle, the user may be given an opportunity to use the subtitle text for one or more purposes, including, but not limited to: sending the subtitle as a Short Messaging Service (SMS) message, Multi Media Service (MMS) message, or the like; storing the subtitle as a calendar note; storing the subtitle with a contact name; and the like.

An example use of such an embodiment is a user who is planning to watch a movie and who wants to use a particular phrase from the movie in a context other than viewing the text of the phrase a subtitle while watching the movie. For example, suppose the user is watching “Terminator 2” in a mobile television application, which may be based on DVB-H technology. And suppose that the user knows that this movie has one or more famous phrases that the user would like to capture on the mobile device for further use. Therefore, the user sets up a personal monitoring profile/filter in the mobile TV application. The profile may have one or more definitions such as: monitor and capture: (1) [metadata; famous phrases]; and/or (2) [subtitle text; Hasta la vista, Baby!].

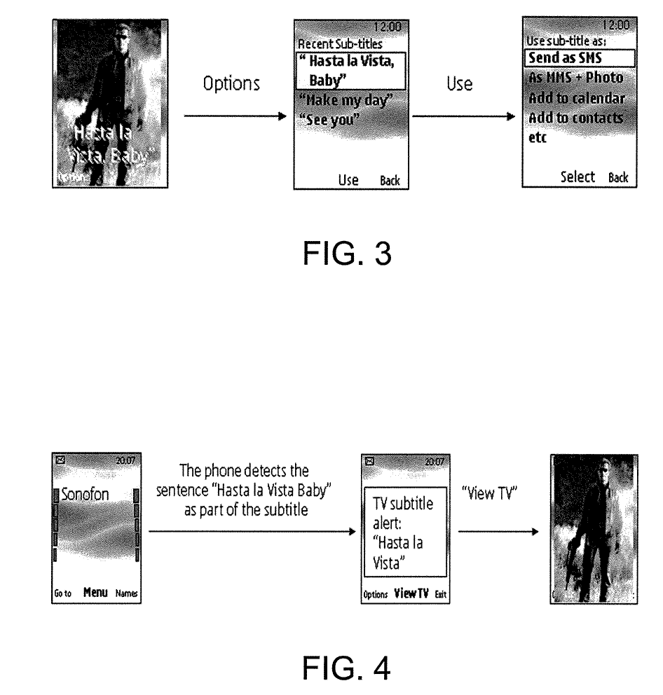

FIG. 3 depicts example media content receiver terminal display screen shots showing an example of sending a sub-title of interest as an SMS message in accordance with an aspect of the invention. By activating the “Options” control, the Recent Sub-Titles page is shown. Then, by the user activating the “Use” control, the “Use sub-title as:” screen is displayed.

For another example use of such an embodiment, assume a user likes to have new video ring tones (having video and/or audio content) on his mobile device. Therefore, he sets up a personal monitoring profile/filter, e.g. in a Profiles application or in a ring tone application, for monitoring desired content from a broadcast stream with specific metadata, such as [metadata; famous phrases]. The monitoring may occur when a mobile TV application is on. When detection by the profile/filter happens, related media content may be stored by the mobile device. The user may later see and scroll through the stored media content in a media application, or now the new ring tones/images, through the profiles or the ring tone applications, and select a new ring tone/image for the ring tone/image of the mobile device.

In accordance with another embodiment, subtitles of media content, e.g., broadcast television programs, running in the background on a media content receiver terminal may be scanned based on configurable criteria input by a user. For instance, a user may specify a word, multiple words, a sentence or metadata, or the like, and may assign an “alarm” to the specifiedcriteria. A user may also specify a specific media channel to perform the scanning on; or the user might specify multiple media channels. The media content receiver terminal may then continuously scan the subtitles being transmitted on the specified media channels without displaying the subtitles. If there is a match, the user will be notified via an alarm. When notified, the user may be offered an easy way to change to the media channel on which the match was found.

An example use case for such an embodiment would be when a user has already seen a specific movie, so the user chooses to write messages, check the user's calendar, and the like while watching the movie. However, the user wants to be notified when a particular scene occurs, such as, when Arnold Schwarzenegger says “Hasta 1a vista, baby!” in Terminator 2. After setting up notification for this phrase, the user will then get a notification when this scene happens, and the user can quickly switch to the media rendering application to view the desired scene.

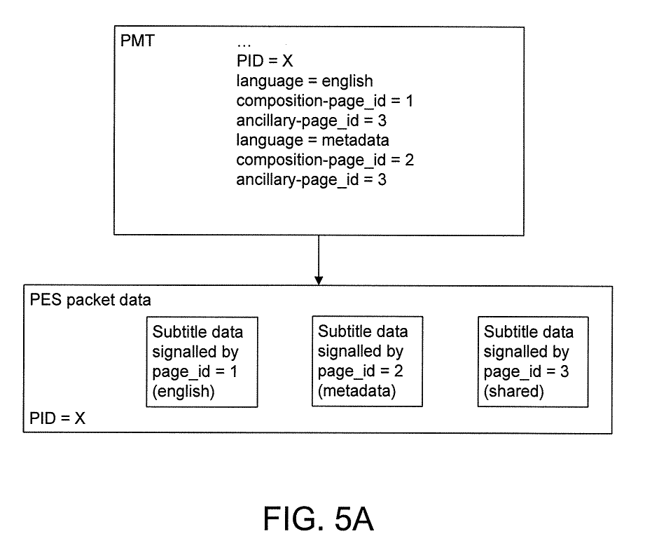

FIG. 4 depicts example media content receiver terminal display screen shots showing an example of viewing a desired scene of a movie in response to a user configured sub-title alarm in accordance with an aspect of the invention. When the sub-title alarm is activated, the “TV subtitle alert” screen is displayed. This display screen includes a “View TV” user control that, when activated turns on the television viewing application to display the scene of interest.

Another example use case would be a user who likes the television series “Friends,” but the user is unaware of when different television channels are broadcasting the series. Therefore, the user sets an alarm whenever the words “Friends,” “Chandler,” or “Phoebe” are transmitted as part of a sub-title. These words may, of course, be contained in other sentences of other films and series, but the user still wants to be notified, and can then easily switch to “Friends” when the series start.

As such, this embodiment provides a new way of consuming broadcast media, by allowing the user to do other things while the media rendering application is running in the “background.” In accordance with an embodiment, a simple and efficient way of switching to the media rendering application when things of interest occur is provided. When the terminal is mobile, it can be useful to background search for a user's favourite television show by searching for specific subtitle words, such as, when a user is travelling abroad and seldom knows the television broadcast schedules.

In accordance with one or more aspects of the invention, processing of subtitles may be performed in accordance with modified versions of the following standards: ETSI 300 743 and 3GPP TS 26.245. As indicated in section 4.1 of ETSI 300 743, that standard provides a syntax for decoding subtitle streams, which convey one or more subtitle services. Each such service contains textual and/or graphical information used to provide subtitles. According to ETSI 300 743, separate subtitle services may be used, to convey subtitles in several languages.

Referring to examples above, in accordance with at least one aspect of the invention, the “famous phrases” may be a specific metadata determination that defines that comments, scenes, or moments associated with that metadata definition should be captured and stored with related/defined video and/or audio content and/or subtitle content. “Hasta 1a vista, Baby!” is free text that may additionally define which specific (or additional) famous phrase should be captured and stored from the subtitle text field. The captured and stored content may be related subtitles, audio, and/or video.

In accordance with an aspect of the invention, a media monitoring engine, which is associated with the mobile video application, may monitor one or more subtitle streams (IP streams) received by the mobile video application in accordance with information specified by the personal monitoring profile. A first subtitle stream may provide subtitle content related to the media stream, and a second subtitle stream, which may be referred to as a metadata stream, may provide metadata information related to the media stream and/or the first subtitle stream. The metadata stream may be separated from the subtitle streams by an identification code attached to the metadata stream (IP packets) by a broadcasting service provider. Both streams may be monitored in parallel, and when there is a hit in the metadata stream or the subtitle stream (depending on the set personal monitoring profile), media content relating to the hit may be captured and stored from the media content stream.

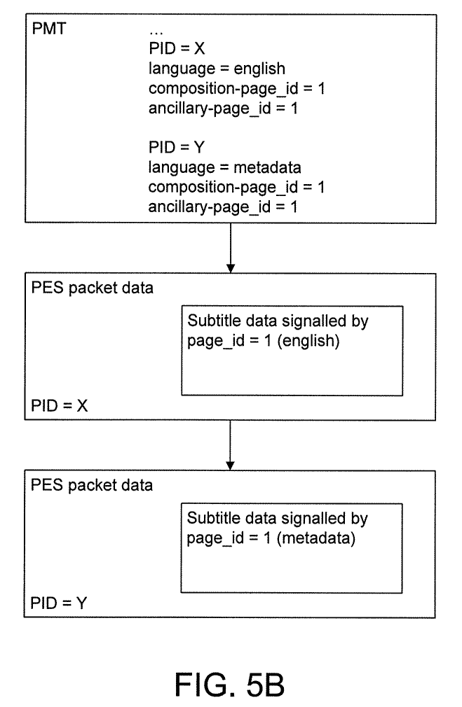

FIG. 5A shows an example of using language definitions, in a manner similar to standard ESTI 300 743, to distinguish between a subtitle stream and an associated metadata stream in accordance with an aspect of the invention. Subtitle streams and the metadata stream may have a common transport packet ID (PID) codes and may be identified separately by using different language definitions as shown in FIG. 5A. Other subtitle descriptors may be used for distinguishing between subtitle streams and the metadata stream. For example, PID, composition page-id, and/or ancillary page-id may be used for distinguishing between subtitle streams and the metadata stream.

FIG. 5B shows an example of using transport packet identifiers by standard ESTI 300 743 to distinguish between a subtitle stream and an associated metadata stream in accordance with an aspect of the invention. Subtitle streams and the metadata stream may be identified separately by using different transport packet ID codes. For example in FIG. 5, the English subtitle stream has a PID of X, and the metadata stream has a PID of Y, as shown in the program map table (PMT). Other subtitle descriptors may be used for distinguishing between subtitle streams and the metadata stream. For example, composition page-id, ancillary page-id, and/or language definition (“language=metadata”) may be used for distinguishing between subtitle streams and the metadata stream.

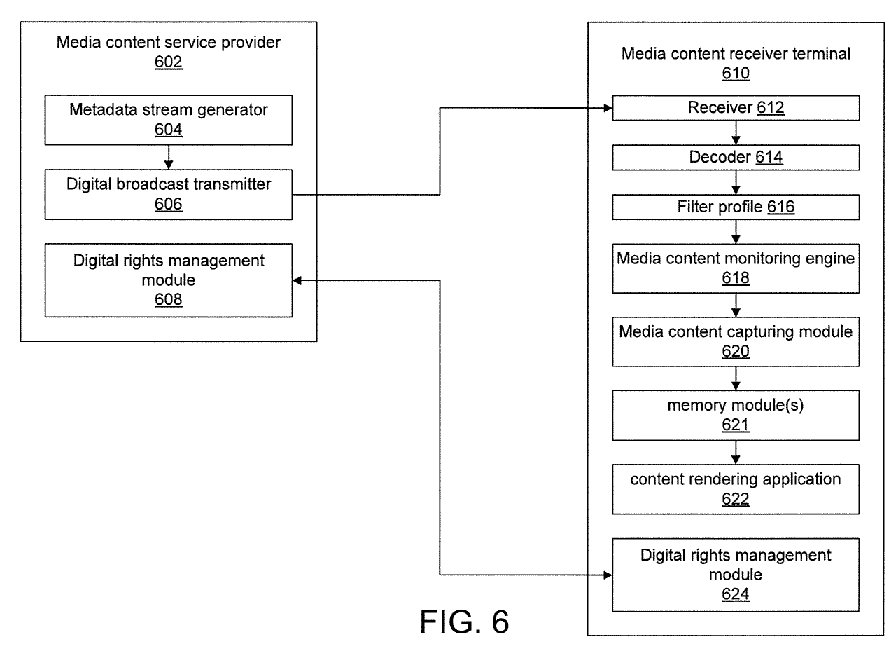

FIG. 6 is a schematic diagram of a media content service provider and a media content receiver terminal in accordance with aspects of the invention. The media content service provider 602 contains a metadata stream generator 604, a digital broadcast transmitter 606, and a digital rights management module 608. The media content receiver terminal 610 contains a receiver 612, decoder 614, filter profile 616, media content monitoring engine 618, media content capturing module 620, content rendering application 622, a digital rights management module 624, and one or more memory modules 621 for buffering received content, storing captured media content, storing the filter profile, and storing DRM information.

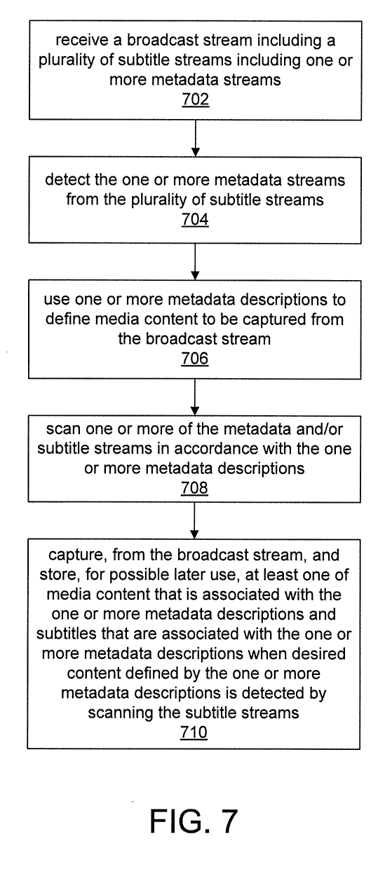

FIG. 7 is a flow chart showing steps performed by a media content receiver terminal in accordance with an aspect of the invention. A broadcast stream, including a plurality of subtitle streams, including one or more metadata streams, is received, as shown at 702. The one or more metadata streams are detected from the plurality of subtitle streams, as shown at 704. One or more metadata descriptions are used to define media content to be captured from the broadcast stream, as shown at 706. One or more of the metadata and/or subtitle streams are scanned in accordance with the one or more metadata descriptions, as shown at 708. And, when desired content defined by the one or more metadata descriptions is detected by performing the scanning step, at least one of media content that is associated with the one or more metadata descriptions and subtitles that are associated with the one or more metadata descriptions are captured, from the broadcast stream, and stored, for possible later use, as shown at 710.

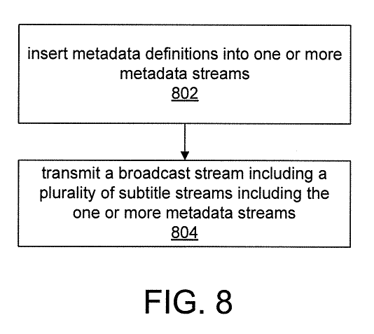

FIG. 8 is a flow chart showing steps performed by a media content service provider in accordance with an aspect of the invention. Metadata definitions are inserted into one or more metadata streams, as shown at 802. And a broadcast stream, including a plurality of subtitle streams, including the one or more metadata streams, is transmitted, as shown at 804.

In accordance with an aspect of the invention, the presentation time stamp (PTS) for the subtitle text may be used as a time stamp for media content to be captured.

The metadata stream (i.e. the second stream) may not be displayed on the display. Instead, it may be monitored in the background by the media monitoring engine. Alternatively, the metadata stream may be displayed as an icon or as text, such as “famous phrase” on the terminal's display. If the icon and/or text is displayed, a user may enter user input to capture the content by activating an appropriate user-interface control, including, but not limited to, pressing a particular button or clicking on the icon.

In accordance with an aspect of the invention, the captured content may have a preview function/option that allows the content to be previewed a limited number of times for content/quality check before a digital rights management (DRM) license is offered for purchase. An option for this may be presented on the terminal's display. Information pertinent to the license may be transmitted via a backchannel over a wireless telecommunication network to the service provider/content owner. Once the license is paid for, a license code may be transmitted back to the mobile video application over the wireless telecommunication network, and the captured content maybe used for purposes other than display with the associated content and with different applications on the terminal.

A metadata definition [metadata; (attribute); (scene)] may be used for defining a specific part/scene of the media content stream that should be captured and stored. The scene attribute may define starting and ending points for the captured stream.

When a desired famous phrase is captured and stored, the stored content may be further used for various purposes, including but not limited to, as a ring tone/image, as an image for persons in a contacts list, and the like.

In accordance with an aspect of the invention, there may be a metadata stream generator associated with the service provider/system side. The metadata generator may create and synchronize the metadata stream with the content stream and/or the subtitle stream. When creating the metadata stream the metadata generator may place an identification code into one or more subtitle streams (IP packets) to identify it/them as a metadata stream.

Further, the service provider/system side may have a licensing/DRM module, including a billing module, for the captured content.

In accordance with an aspect of the invention, the subtitling and the metadata stream may be broadcast in a code based format so that the media monitoring engine may understand it as a code string. In another aspect of the invention, the subtitling stream may be transmitted in a bit-map format. But then its content cannot be monitored, only captured.

The following are examples of metadata definitions:

[metadata; famous phrase]
[metadata; famous song]
[metadata; famous scenery]
[metadata; famous portrait]
[metadata; famous person]
[metadata; famous image]
[metadata; famous phrase; Hasta 1a vista, baby!]
[metadata; commercial]
[metadata; bookmark]
[metadata; email]
[metadata; phone number]
[metadata; contact information]
[metadata; (attribute); (PTS)]
[metadata; (attribute); (scene)]
[metadata; (attribute); (part)]
[metadata; (attribute); (start point: end point)]
[metadata; (attribute); (PTS), (DRM code)]
[metadata; (attribute); (icon code)]

One or more aspects of the invention may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), application specific integrated circuits (ASIC) and the like.

Embodiments of the invention include any novel feature or combination of features disclosed herein either explicitly or any generalization thereof. While embodiments of the invention have been described with respect to specific examples including presently preferred modes of carrying out the invention, those skilled in the art will appreciate that there are numerous variations and permutations of the above described systems and techniques. Thus, the spirit and scope of the invention should be construed broadly as set forth in the appended claims.

We claim:

1. An apparatus comprising:
a digital broadcast receiver configured to receive a broadcast stream including a plurality of subtitle streams including one or more metadata streams;
a decoder configured to detect the one or more metadata streams from the plurality of subtitle streams;
a filter profile configured with one or more metadata descriptions for defining media content to be captured from the broadcast stream;
a media content monitoring engine configured to scan one or more of the subtitle streams in accordance with the one or more metadata descriptions;
a media content capturing module configured to capture, from the broadcast stream, and store, for possible later use, media content that is associated with the one or more metadata descriptions when desired content defined by the one or more metadata descriptions is detected by the media content monitoring engine.

2. The apparatus of claim 1, wherein the one or more metadata streams are identified as metadata streams by at least one of: one or more transport packet identifiers in the one or more metadata streams, one or more composition page identifiers in the one or more metadata streams, and one or more ancillary page identifiers in the one or more metadata streams.

3. The apparatus of claim 1, wherein the broadcast stream includes at least one of digital video content and digital audio content.

4. The apparatus of claim 1, wherein the one or more metadata descriptions specify a famous instance of content.

5. The apparatus of claim 4, wherein the famous instance of content is at least one of a famous phrase, a famous song, famous scenery, a famous portrait, a famous portrait, a famous person, and a famous image.

6. The apparatus of claim 1, wherein the one or more metadata descriptions specify a desired start point and a desired end point.

7. The apparatus of claim 1, wherein the one or more metadata descriptions correspond to at least one of one or more subtitle streams and one or more metadata streams.

8. The apparatus of claim 1, wherein the content monitoring engine is configured to scan one or more of the metadata streams.

9. The apparatus of claim 1, wherein the media content capturing module is configured to render an indication to a terminal user that desired content defined by the one or more metadata descriptions has been detected.

10. The apparatus of claim 9, wherein rendering the indication that desired content has been detected further comprises at least one of displaying at least one of an icon and text to a user, providing an audible indication, requesting user input regarding whether the detected content should be stored for later possible use, and, when a video display application is running in the background, requesting user input from the user to determine whether the user wants to view the detected content.

11. The apparatus of claim 10, wherein, the video display application displays the detected content in response to user input indicating that the user wants to view the detected content.

12. The apparatus of claim 1, further comprising a digital rights management module configured to store digital rights management information for the media content that is associated with the one or more metadata descriptions.

13. The apparatus of claim 12, wherein the digital rights management module is configured to: send a request to at least one of a broadcast stream provider and a digital rights management owner for a license to the captured media content, receive a digital rights management license in response to the sent request, and store the received digital rights management license with the captured media content.

14. The apparatus of claim 1, wherein the apparatus presents to a terminal user usage options for the captured media content.

15. The apparatus of claim 14, wherein the usage options include using the captured media content as a video ring tone.

16. The apparatus of claim 1, wherein the media content that is associated with the one or more metadata descriptions includes subtitles that are associated with the one or more metadata descriptions.

17. A method comprising:
receiving a broadcast stream including a plurality of subtitle streams including one or more metadata streams;
detecting the one or more metadata streams from the plurality of subtitle streams;
using one or more metadata descriptions to define media content to be captured from the broadcast stream;
scanning one or more of the subtitle streams in accordance with the one or more metadata descriptions; and
capturing, from the broadcast stream, and storing, for possible later use, media content that is associated with the one or more metadata descriptions when desired content defined by the one or more metadata descriptions is detected by performing the scanning step.

18. The method of claim 17, wherein the one or more metadata streams are identified as metadata streams by at least one of: one or more transport packet identifiers in the one or more metadata streams, one or more composition page identifiers in the one or more metadata streams, and one or more ancillary page identifiers in the one or more metadata streams.

19. The method of claim 17, wherein the broadcast stream includes at least one of digital video content and digital audio content.

20. The method of claim 17, wherein the one or more metadata descriptions specify a famous instance of content.

21. The method of claim 17, further comprising rendering an indication to a terminal user that desired content defined by the one or more metadata descriptions has been detected.

22. The method of claim 17, wherein the media content that is associated with the one or more metadata descriptions is stored with associated digital rights management information.

23. The method of claim 17, further comprising presenting to a terminal user usage options for the captured media content, wherein the usage options include using the captured media content as a video ring tone.

24. The method of claim 17, wherein the media content that is associated with the one or more metadata descriptions includes subtitles that are associated with the one or more metadata descriptions.

25. An apparatus comprising:
a metadata stream generator that inserts a plurality of metadata definitions into one or more metadata streams; and
a digital broadcast transmitter configured to transmit a broadcast stream including a plurality of subtitle streams including the one or more metadata streams.

26. The apparatus of claim 25, wherein the one or more metadata definitions specify a famous instance of content.

27. The apparatus of claim 25, further comprising a digital rights management module configured to: receive a request from a user terminal for a license to captured media content, accept payment for the requested license, and send a digital rights management license in response to the received request.

28. The apparatus of claim 25, wherein the one or more metadata streams are identified as metadata streams by at least one of: one or more transport packet identifiers in the one or more metadata streams, one or more composition page identifiers in the one or more metadata streams, and one or more ancillary page identifiers in the one or more metadata streams.

29. The apparatus of claim 25, wherein the broadcast stream includes at least one of digital video content and digital audio content.

30. A method comprising:
inserting a plurality of metadata definitions into one or more metadata streams; and
transmitting a broadcast stream including a plurality of subtitle streams including the one or more metadata streams.

31. The method of claim 30, wherein the one or more metadata definitions specify a famous instance of content.

32. The method of claim 30, further comprising: receiving a request from a user terminal for a license to captured media content, accepting payment for the requested license, and sending a digital rights management license in response to the received request.

33. The method of claim 32, wherein the one or more metadata streams are identified as metadata streams by at least one of: one or more transport packet identifiers in the one or more metadata streams, one or more composition page identifiers in the one or more metadata streams, and one or more ancillary page identifiers in the one or more metadata streams.

34. A system comprising:
a media content service provider having a first computer readable medium that contains computer executable instructions for causing the media content service provider to perform operations comprising:
inserting a plurality of metadata definitions into one or more metadata streams, and
transmitting a broadcast stream including a plurality of subtitle streams including the one or more metadata streams; and
a terminal having a second computer readable medium that contains computer executable instructions for causing the terminal to perform operations comprising:
receiving the broadcast stream;
detecting the one or more metadata streams from the plurality of subtitle streams;
using one or more metadata descriptions to define media content to be captured from the broadcast stream;
scanning one or more of the subtitle streams in accordance with the one or more metadata descriptions; and
capturing, from the broadcast stream, and storing, for possible later use, media content that is associated with the one or more metadata descriptions when desired content defined by the one or more metadata descriptions is detected by performing the scanning step.

35. The system of claim 34, wherein the one or more metadata definitions specify a famous instance of content.

36. The system of claim 34, wherein the one or more metadata streams are identified as metadata streams by at least one of: one or more transport packet identifiers in the one or more metadata streams, one or more composition page identifiers in the one or more metadata streams, and one or more ancillary page identifiers in the one or more metadata streams.

37. The system of claim 34, wherein the terminal further comprises a digital rights management module configured to store digital rights management information for the media content that is associated with the one or more metadata descriptions.

38. The system of claim 34, wherein the media content that is associated with the one or more metadata descriptions includes subtitles that are associated with the one or more metadata descriptions.
